(19) United States
(12) Patent Application Publication
(10) Pub. No.: US 2026/0257339 A1
(43) Pub. Date: Sep. 3, 2026

(54) Parallel Linkage Mechanism and Industrial Robot

(71) Applicant: ABB Schweiz AG, Baden (CH)

(72) Inventors: Tommi Paananen, Västerås (SE); Tomas Botold, Västerås (SE); Jiangwei Huang, Västerås (SE); Shanghua Li, Västerås (SE); Roger Pons, Barcelona (ES); Miguel-Angel Trujillo, Barcelona (ES); Esteve Guil, Barcelona (ES)

(73) Assignee: ABB Schweiz AG, Baden (CH)

(21) Appl. No.: 19/631,159

(22) Filed: Mar. 27, 2026

Related U.S. Application Data
(63) Continuation of application No. PCT/EP2023/077605, filed on Oct. 5, 2023.

(51) Int. Cl. B25J 9/00

(52) U.S. Cl. CPC B25J 9/0048

(57) ABSTRACT

A parallel linkage mechanism includes a support member; a connection joint; a first arm interconnecting the support member and the connection joint and including a first intermediate joint and a first driving link rotatable around a first axis; a second arm interconnecting the support member and the connection joint in parallel with the first arm, the second arm including a second intermediate joint and a second driving link rotatable around a second axis, the first and second axes defining a reference plane; wherein the parallel linkage mechanism is configured to adopt a state where the first and second driving links are crossed, the connection joint is positioned on a primary side of the reference plane, and the first and second intermediate joints are positioned on an opposite secondary side of the reference plane.

### CROSS-REFERENCE TO RELATED APPLICATIONS

The instant application claims priority to International Patent Application No. PCT/EP2023/077605, filed October 5, 2023, which is incorporated herein in its entirety by reference.

### FIELD OF THE DISCLOSURE

The present disclosure generally relates to industrial robots and, more particularly, to a parallel linkage mechanism and an industrial robot comprising such parallel linkage mechanism.

### BACKGROUND OF THE INVENTION

Industrial robots are used in a wide range of automated applications. In many applications, an industrial robot is used to load a workpiece to a machine and to unload the workpiece therefrom after the machine has performed an operation on the workpiece. The loading of workpieces in this way may be referred to as tending.

US 5522275 A discloses an industrial robot for use as an inter-press robot. The industrial robot comprises a base arranged in a space between two presses; a pair of arms rotatably mounted to the base; a pair of forearms rotatably mounted to the arms, the ends of the forearms being articulated around a common axis; a forearm extension rotatably supporting a wrist; and a tool flange attached to the wrist for supporting a gripping member.

### BRIEF SUMMARY OF THE INVENTION

The present disclosure generally describes an improved parallel linkage mechanism for an industrial robot, and also an improved industrial robot.

Embodiments include providing a parallel linkage mechanism comprising two parallel arms interconnecting a support member and a connection joint in parallel and where two driving links of the arms can be oriented upwards with respect to their actuation axes, the connection joint can be positioned very close to the support member enabling both a small footprint and an increased range of movements of the parallel linkage mechanism.

According to a first aspect, there is provided a parallel linkage mechanism for an industrial robot, the parallel linkage mechanism comprising a support member; a connection joint; a first arm interconnecting the support member and the connection joint, the first arm including a first intermediate joint and a first driving link interconnecting the support member and the first intermediate joint; a first actuator arranged to drive the first driving link to rotate relative to the support member around a first axis; a second arm interconnecting the support member and the connection joint in parallel with the first arm, the second arm including a second intermediate joint and a second driving link interconnecting the support member and the second intermediate joint; and a second actuator arranged to drive the second driving link to rotate relative to the support member around a second axis, the second axis and the first axis defining a reference plane; wherein the parallel linkage mechanism is configured to adopt a state where the first driving link and the second driving link are crossed, the connection joint is positioned on a primary side of the reference plane, and the first intermediate joint and the second intermediate joint are positioned on an opposite secondary side of the reference plane.

The parallel linkage mechanism provides a large working range of the connection joint. By extending the first and second arms, the connection joint can be positioned far away from the support member. In a state of the parallel linkage mechanism where the first and second driving links are crossed and the first and second intermediate joints are positioned on the secondary side, the connection joint can be positioned at least very close to the reference plane, or even pass the reference plane to the secondary side thereof. This ability of the parallel linkage mechanism enables a greatly reduced footprint and a greatly increased range of movements of the connection joint in comparison with a parallel linkage mechanism where the intermediate joints are always positioned on the primary side of such reference plane. The small footprint combined with a large range of movements makes the parallel linkage mechanism very well suited for use in manipulation operations in tight spaces, and/or enables such spaces to be made tighter to reduce an overall footprint of an application, such as a press application comprising two machine presses tended by the industrial robot therebetween. An industrial robot comprising the parallel linkage mechanism according to the first aspect may however be used in many applications other than press applications.

### BRIEF DESCRIPTION OF THE SEVERAL VIEWS OF THE DRAWING(S)

FIG. 1 is a diagram of a side view of an industrial robot used in an application according to one example of the present disclosure.

FIG. 2 is a diagram of a side view of an industrial robot in accordance with the disclosure.

FIG. 3 is a partial perspective side view of an industrial robot in accordance with the disclosure.

FIG. 4 is a partial side view of the industrial robot of FIG. 3 when adopting a compact state.

FIG. 5 is a partial top view of the industrial robot of FIG. 4.

### DETAILED DESCRIPTION OF THE INVENTION

In the following, a parallel linkage mechanism and an industrial robot comprising such parallel linkage mechanism, will be described. The same or similar reference numerals will be used to denote the same or similar structural features.

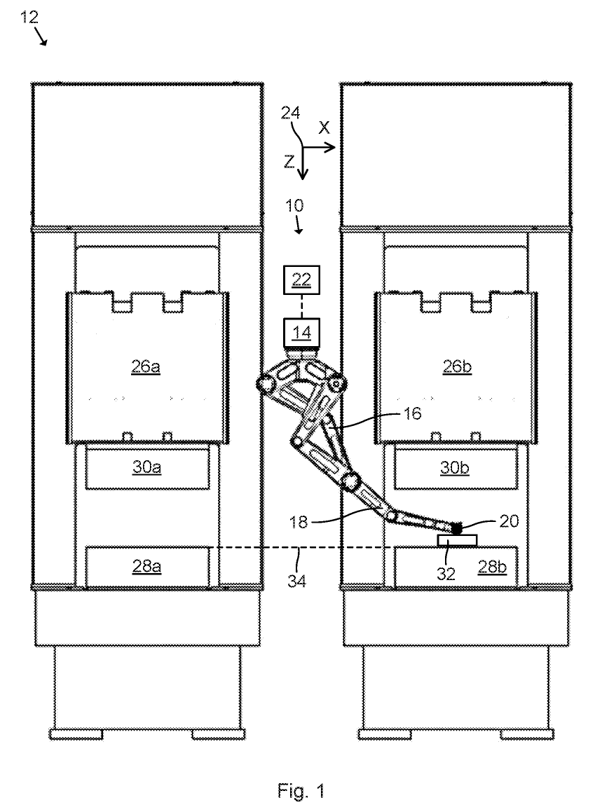

FIG. 1 schematically represents a side view of an industrial robot 10 used in an application 12 according to one example. The industrial robot 10 of this example comprises a stationary base 14, a parallel linkage mechanism 16, a serial linkage mechanism 18 and an end effector 20. The industrial robot 10 also comprises an electronic control system 22. The base 14, the parallel linkage mechanism 16, the serial linkage mechanism 18 and the end effector 20 constitute one example of a manipulator of the industrial robot 10.

FIG. 1 also shows a Cartesian coordinate system 24 for reference purposes. In this example, the Z-axis of the coordinate system 24 is vertical. The control system 22 is configured to control operation of the manipulator, for example by using commands in relation to the coordinate system 24.

The application 12 of this specific and non-limiting example comprises a first machine press 26a and a second machine press 26b. The first machine press 26a comprises a first bed 28a and a first ram 30a movable relative to the first bed 28a to press a workpiece 32 therebetween in a first manner. The second machine press 26b comprises a second bed 28b and a second ram 30b movable relative to the second bed 28b to press the workpiece 32 therebetween in a second manner, different from the first manner. A distance between the first bed 28a and the second bed 28b may for example be at least 2 m, such as 5 m to 6 m.

The industrial robot 10 is positioned horizontally between the first and second machine presses 26a and 26b. The industrial robot 10 may for example pick the workpiece 32 from the first bed 28a after completion of the pressing by the machine press 26a and place the workpiece 32 on the second bed 28b. After completion of the pressing by the second machine press 26b, the workpiece 32 may be picked again by the industrial robot 10 or may be picked by another industrial robot (not illustrated), e.g., to the right of the second machine press 26b in FIG. 1.

The industrial robot 10 of this example is top mounted. This makes it possible to arrange the first and second machine presses 26a and 26b horizontally close to each other. As shown, a space between the first and second machine presses 26a and 26b is very limited. FIG. 1 further shows a straight line 34 extending between the first and second beds 28a and 28b. The line 34 is referred to again later in the description.

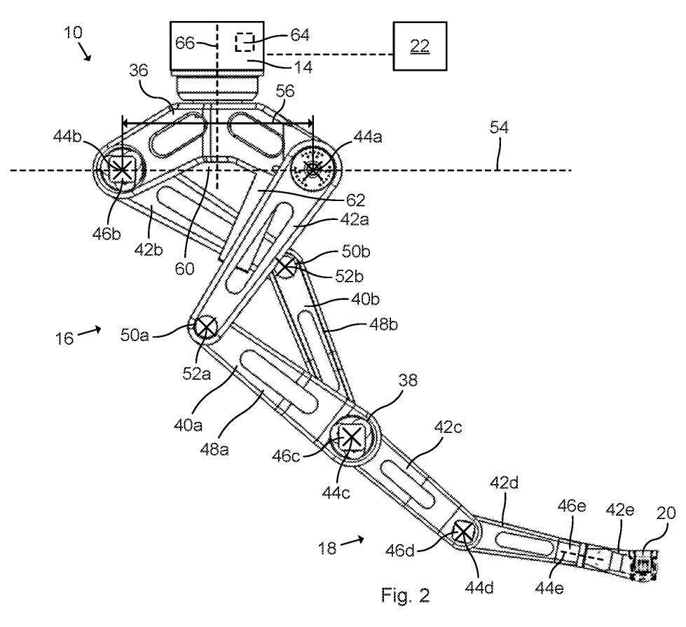

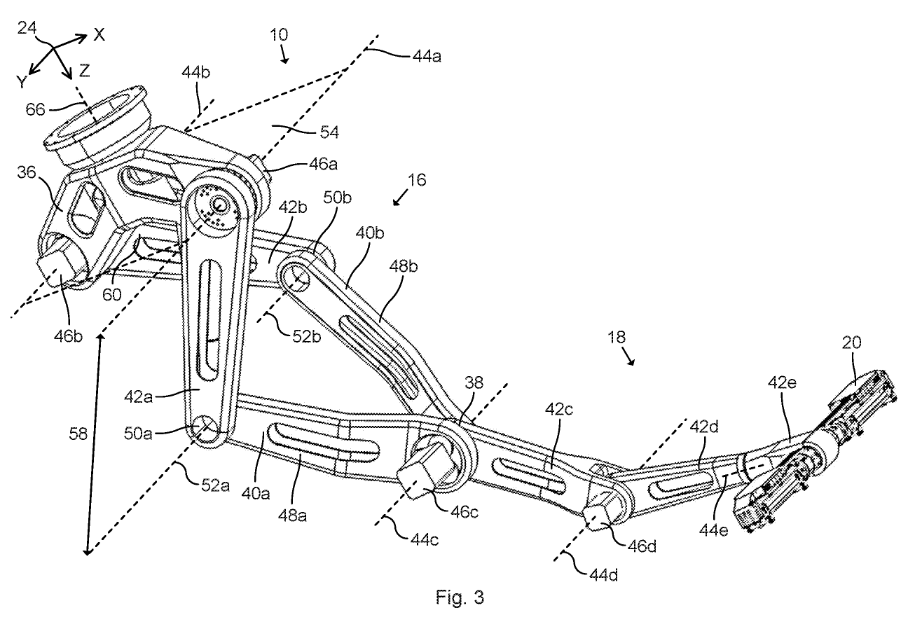

FIG. 2 schematically represents a side view of the industrial robot 10, and FIG. 3 schematically represents a partial perspective side view of the industrial robot 10. With collective reference to FIGS. 2 and 3, the parallel linkage mechanism 16 comprises a support member 36, a connection joint 38, a first arm 40a and a second arm 40b. The first and second arms 40a and 40b of this example lie substantially in a common plane, here the XZ-plane of the coordinate system 24. The parallel linkage mechanism 16 of this example is thus substantially planar.

The first arm 40a interconnects the support member 36 and the connection joint 38. The first arm 40a comprises a first driving link 42a rotatably connected to the support member 36 for rotation around a first axis 44a. The parallel linkage mechanism 16 further comprises a first actuator 46a for driving rotation of the first driving link 42a around the first axis 44a. The first arm 40a of this example further comprises a first driven link 48a rotatably connected to the first driving link 42a at a first intermediate joint 50a. Thus, the first driving link 42a interconnects the support member 36 and the first intermediate joint 50a, and the first driven link 48a interconnects the first intermediate joint 50a and the connection joint 38. The first intermediate joint 50a provides relative rotation between the first driving link 42a and the first arm 40a around a first intermediate axis 52a. The first intermediate axis 52a is here parallel with the first axis 44a.

The second arm 40b interconnects the support member 36 and the connection joint 38 in parallel with the first arm 40a. The second arm 40b comprises a second driving link 42b rotatably connected to the support member 36 for rotation around a second axis 44b. The parallel linkage mechanism 16 further comprises a second actuator 46b for driving rotation of the second driving link 42b around the second axis 44b. The second arm 40b of this example further comprises a second driven link 48b rotatably connected to the second driving link 42b at a second intermediate joint 50b. Thus, the second driving link 42b interconnects the support member 36 and the second intermediate joint 50b, and the second driven link 48b interconnects the second intermediate joint 50b and the connection joint 38. The second intermediate joint 50b provides relative rotation between the second driving link 42b and the second arm 40b around a second intermediate axis 52b. The second intermediate axis 52b is here parallel with the second axis 44b. The second driven link 48b is rotatably connected to the first driven link 48a at the connection joint 38.

By controlling operation of the first and second actuators 46a and 46b, the connection joint 38 can move in a plane, here the XZ-plane of the coordinate system 24. In FIGS. 2 and 3, the first and second driving links 42a and 42b are crossed, e.g., as seen in a direction parallel with the first axis 44a. Due to the first and second driving links 42a and 42b being crossed, the parallel linkage mechanism 16 is compact in the X-direction, here in a horizontal direction.

The first and second axes 44a and 44b define a reference plane 54. The first and second axes 44a and 44b of this example are parallel but may also lie in, and define, the reference plane 54 if being non-parallel. The first and second axes 44a and 44b and the reference plane 54 are all horizontal in this example.

FIG. 2 shows a distance 56 between the first and second axes 44a and 44b, and FIG. 3 shows a length 58 of the first driving link 42a. In this example, the length 58 equals the distance 56. The length 58 of the first driving link 42a may be defined as a distance between the first axis 44a and the first intermediate axis 52a. A length of the second driving link 42b defined in a corresponding manner also equals the distance 56.

The support member 36 of this example is generally V-shaped. The support member 36 comprises an aperture 60 between the first and second axes 44a and 44b.

The parallel linkage mechanism 16 of this example further comprises a balancing device 62. The balancing device 62 here assists the first actuator 46a to counteract gravity loads acting on the first driving link 42a, such as a weight of the serial linkage mechanism 18 and a weight of the workpiece 32. The balancing device 62 may for example comprise a spring-biased piston-cylinder apparatus interconnecting the support member 36 and the first driving link 42a.

The industrial robot 10 of this example further comprises a base actuator 64 arranged to drive the support member 36 to rotate relative to the base 14 around a support member axis 66. The industrial robot 10 of this example can however move between the first and second machine presses 26a and 26b without actuation of the base actuator 64. The base actuator 64 may for example be used to reorient the parallel linkage mechanism 16, e.g., into alignment with the YZ-plane of the coordinate system 24.

The serial linkage mechanism 18 of this example interconnects the parallel linkage mechanism 16 and the end effector 20. Both the serial linkage mechanism 18 and the parallel linkage mechanism 16 lie substantially in a common plane, here the XZ-plane of the coordinate system 24.

The serial linkage mechanism 18 of this example comprises a third driving link 42c and a third actuator 46c arranged to drive the third driving link 42c to rotate relative to each of the first arm 40a and the second arm 40b around a third axis 44c. The third axis 44c is parallel with the first axis 44a. The third axis 44c of this example coincides with the connection joint 38. Thus, at the connection joint 38, each of the first driven link 48a, the second driven link 48b and the third driving link 42c may rotate relative to each other around the third axis 44c. The third actuator 46c may for example drive rotation of the third driving link 42c relative to the first driven link 48a around the third axis 44c.

The serial linkage mechanism 18 of this example further comprises a fourth driving link 42d and a fourth actuator 46d arranged to drive the fourth driving link 42d to rotate relative to the third driving link 42c around a fourth axis 44d. Also the fourth axis 44d is here parallel with the first axis 44a.

The serial linkage mechanism 18 of this example further comprises a fifth driving link 42e and a fifth actuator 46e arranged to drive the fifth driving link 42e to rotate relative to the fourth driving link 42d around a fifth axis 44e. The fifth axis 44e is here transverse to the fourth axis 44d. Moreover, the fifth axis 44e of this example intersects the fourth axis 44d. In this example, the end effector 20 is connected to the fifth driving link 42e.

Each of the actuators 46a-46e and 64 is here a rotational actuator. The use of only rotational actuators 46a-46e and 64, in contrast to using one or more linear actuators, enables a more compact and cost-efficient design of the industrial robot 10. Also cable routing to the respective actuators 46a-46e is simplified by using rotational actuators. Moreover, due to the first and second actuators 46a and 46b operating in parallel, the torques provided can be relatively low.

Since the parallel linkage mechanism 16 and the serial linkage mechanism 18 lie substantially in a common plane, here the XZ-plane, the industrial robot 10 is very compact in a direction transverse to this plane, here the Y-direction. Due to the first and second driving links 42a and 42b being crossed, the parallel linkage mechanism 16 enables the industrial robot 10 to provide a large working range of the end effector 20 in a narrow space. The industrial robot 10 also has a design of low complexity.

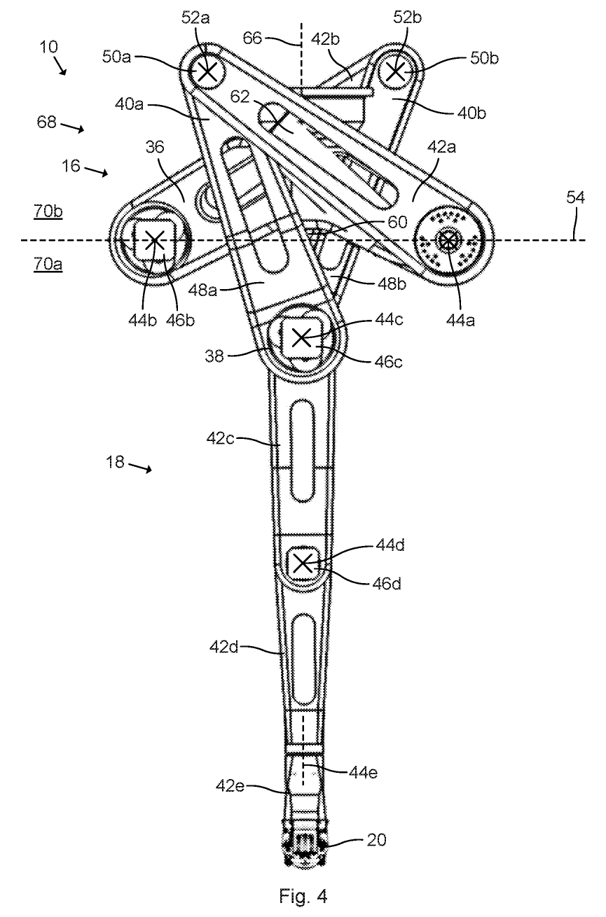

FIG. 4 schematically represents a partial side view of the industrial robot 10 when adopting a state 68. The state 68 may be referred to as a compact state. In the state 68, the first and second driving links 42a and 42b are crossed, the connection joint 38 is positioned on a primary side 70a of the reference plane 54, and the first and second intermediate joints 50a and 50b are positioned on a secondary side 70b of the reference plane 54, opposite to the primary side 70a. In FIG. 4, the first and second driving links 42a and 42b point upwards from the reference plane 54. In this example where the reference plane 54 is horizontal and the industrial robot 10 is top mounted, the primary side 70a is vertically below the reference plane 54. In the state 68, the connection joint 38 can be positioned very close to the support member 36. The parallel linkage mechanism 16 thereby provides a superior combination of compactness and reach of the connection joint 38 close to the support member 36. The connection joint 38 can be driven even further upwards in FIG. 4 and into the aperture 60 such that the connection joint 38 is aligned with the reference plane 54. In this way, the reach and compactness of the parallel linkage mechanism 16 is even further improved.

Referring again to FIG. 1, the ability of the parallel linkage mechanism 16 to adopt the state 68 enables the industrial robot 10 to move the end effector 20 quickly between the first and second beds 28a and 28b without necessarily having to cross the line 34 therebetween and without having to rotate the support member 36 around the support member axis 66. The base actuator 64 and the ability of the support member 36 to rotate relative to the base 14 around the support member axis 66 is thus optional. Moreover, the combination of the parallel linkage mechanism 16 and the serial linkage mechanism 18, and the ability of the parallel linkage mechanism 16 to adopt the state 68 enables an improved motion performance inside the first and second machine presses 26a and 26b.

With collective reference to FIGS. 2, 3 and 4, due to the length 58 of the first driving link 42a equaling the distance 56 between the first and second axes 44a and 44b, the first intermediate axis 52a will not extend outside of the second axis 44b (to the left in FIG. 4) when the first driving link 42a is rotated back towards the primary side 70a around the first axis 44a (in the counterclockwise direction in FIG. 4). The first driving link 42a can thus be maintained within a horizontal footprint of the support member 36.

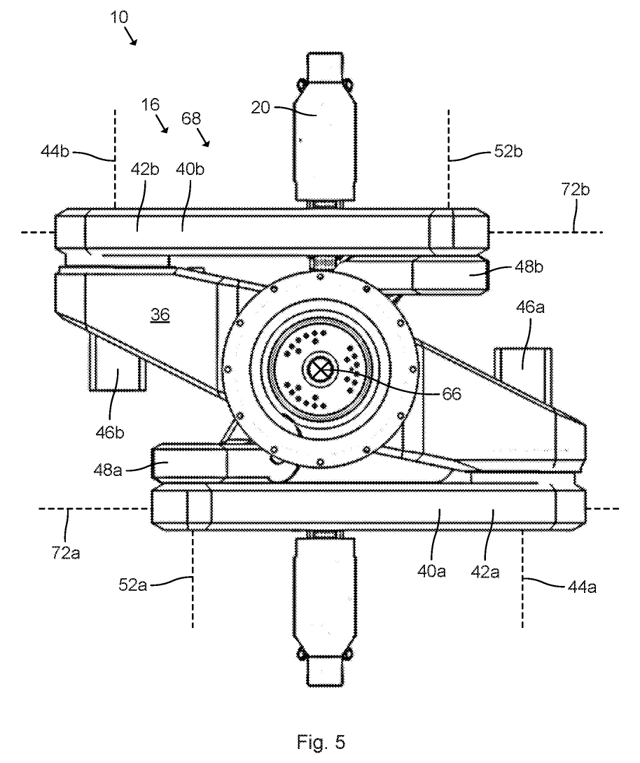

FIG. 5 schematically represents a partial top view of the industrial robot 10. Also in FIG. 5, the parallel linkage mechanism 16 is in the state 68. As can be gathered from FIG. 5, the first driving link 42a is movable in a first plane 72a transverse to the first axis 44a and the second driving link 42b is movable in a second plane 72b transverse to the second axis 44b. In this example, the first and second planes 72a and 72b are vertical and parallel. As shown in FIG. 5, the support member 36 is positioned between the first and second planes 72a and 72b, here entirely positioned therebetween. Moreover, both the first and second driven links 48a and 48b are positioned between the first and second planes 72a and 72b, here entirely positioned therebetween. As shown in FIG. 5, the support member 36 on the one hand, and the first and second driven links 48a and 48b on the other hand, form an X-shape as seen in a direction transverse to the reference plane 54, e.g., along the support member axis 66. Also these features described in connection with FIG. 5 contribute to a compact design of the parallel linkage mechanism 16.

In the context of the present disclosure, the state adopted by the parallel linkage mechanism where the first and second driving links are crossed, and the first and second intermediate joints are positioned on the secondary side of the reference plane may be referred to as a compact state. The first and second driving links may be crossed as seen in a direction along the first axis.

The first and second actuators may be rotational actuators. The first and second axes may be horizontal. The first axis and the second axis may be parallel. In these cases, the first and second arms may be substantially planar, or planar, contributing to the compactness of the parallel linkage mechanism.

A length of the first driving link between the first axis and the first intermediate joint may be between 80 % and 120 %, such as between 90 % and 110 %, such as between 95 % and 105 % of a distance between the first axis and the second axis. This enables the first driving link to be substantially maintained within, or maintained within, a footprint of the support member, e.g., in the reference plane and in a direction parallel with the first axis, when the first intermediate joint is positioned on the reference plane. A length of the second driving link may be substantially equal to, or equal to, the length of the first driving link.

The first driving link may be movable in a first plane transverse to the first axis, and the second driving link may be movable in a second plane transverse to the second axis. In these cases, the support member may be positioned between the first plane and the second plane. This variant of the parallel linkage mechanism further contributes to the compactness thereof. For this variant, the first and second axes may or may not be parallel.

The parallel linkage mechanism may further comprise a first driven link interconnecting the first intermediate joint and the connection joint, and a second driven link interconnecting the second intermediate joint and the connection joint.

The first driven link and the second driven link may be positioned between the first plane and the second plane. Also, this variant contributes to the compactness of the parallel linkage mechanism.

The support member may comprise an aperture between the first axis and the second axis in the reference plane. The aperture may be arranged to receive the connection joint. When the connection joint is received in the aperture, the connection joint may thus be positioned linearly between the first and second axes. By designing the support member in this way, the parallel linkage mechanism can adopt a very compact state where the first and second driving links are crossed and where the first and second intermediate joints are positioned on the secondary side of the reference plane. In this state, the aperture may even permit the connection joint to move through the reference plane from the primary side to the secondary side.

The parallel linkage mechanism may further comprise a balancing device configured to assist the first actuator to counteract gravity forces acting on the first driving link.

According to a second aspect, there is provided an industrial robot comprising a parallel linkage mechanism according to the first aspect and an end effector. The industrial robot may be vertically mounted such that the reference plane is horizontal and such that the primary side is vertically below the reference plane.

The industrial robot may further comprise a base and a base actuator arranged to drive the support member to rotate relative to the base around a support member axis. The base actuator may be a rotational actuator. In cases where the support member is not rotatable relative to the base, the support member may constitute, or form part of, the base of the industrial robot.

The support member axis may be transverse to the reference plane. Thus, the support member axis may or may not be vertical.

The industrial robot may further comprise a serial linkage mechanism connected between the connection joint and the end effector. The base, the parallel linkage mechanism, the serial linkage mechanism and the end effector form one example of a manipulator. In addition to the manipulator, the industrial robot may comprise an electronic control system for controlling the manipulator, such as controlling any actuators thereof.

In some alternative variants, the industrial robot does not comprise the serial linkage mechanism. In such variants, the end effector may be provided at the connection joint.

The serial linkage mechanism may comprise a third driving link and a third actuator arranged to drive the third driving link to rotate relative to each of the first arm and the second arm around a third axis. The third actuator may be a rotational actuator.

The third axis may coincide with the connection joint. This variant contributes to a compact design and an agile performance of the industrial robot. The third axis may be parallel with the first axis.

The serial linkage mechanism may further comprise a fourth driving link and a fourth actuator arranged to drive the fourth driving link to rotate relative to the third driving link around a fourth axis. The fourth actuator may be a rotational actuator. The fourth axis may be parallel with the third axis.

The serial linkage mechanism may further comprise a fifth driving link and a fifth actuator arranged to drive the fifth driving link to rotate relative to the fourth driving link around a fifth axis. The fifth actuator may be a rotational actuator. The fifth axis may be transverse to the fourth axis.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A parallel linkage mechanism for an industrial robot, the parallel linkage mechanism comprising:
a support member;
a connection joint;
a first arm interconnecting the support member and the connection joint, the first arm including a first intermediate joint and a first driving link interconnecting the support member and the first intermediate joint;
a first actuator arranged to drive the first driving link to rotate relative to the support member around a first axis;
a second arm interconnecting the support member and the connection joint in parallel with the first arm, the second arm including a second intermediate joint and a second driving link interconnecting the support member and the second intermediate joint; and
a second actuator arranged to drive the second driving link to rotate relative to the support member around a second axis, the second axis and the first axis defining a reference plane;
wherein the parallel linkage mechanism is configured to adopt a state in which the first driving link and the second driving link are crossed, the connection joint is positioned on a primary side of the reference plane, and the first and second intermediate joints are positioned on an opposite, secondary side of the reference plane.

2. The parallel linkage mechanism of claim 1, wherein the first axis and the second axis are parallel.

3. The parallel linkage mechanism of claim 2, wherein a length of the first driving link between the first axis and the first intermediate joint is between 80 % and 120 % of a distance between the first axis and the second axis.

4. The parallel linkage mechanism of claim 1, wherein the first driving link is movable in a first plane transverse to the first axis, wherein the second driving link is movable in a second plane transverse to the second axis, and wherein the support member is positioned between the first plane and the second plane.

5. The parallel linkage mechanism of claim 1, further comprising a first driven link interconnecting the first intermediate joint and the connection joint, and a second driven link interconnecting the second intermediate joint and the connection joint.

6. The parallel linkage mechanism of claim 5, wherein the first driven link and the second driven link are positioned between the first plane and the second plane.

7. The parallel linkage mechanism of claim 1, wherein the support member comprises an aperture between the first axis and the second axis in the reference plane, the aperture being arranged to receive the connection joint.

8. An industrial robot, comprising:
a parallel linkage mechanism, and
an end effector,
wherein the parallel linkage mechanism includes:
a support member;
a connection joint;
a first arm interconnecting the support member and the connection joint, the first arm including a first intermediate joint and a first driving link interconnecting the support member and the first intermediate joint;
a first actuator arranged to drive the first driving link to rotate relative to the support member around a first axis;
a second arm interconnecting the support member and the connection joint in parallel with the first arm, the second arm including a second intermediate joint and a second driving link interconnecting the support member and the second intermediate joint; and
a second actuator arranged to drive the second driving link to rotate relative to the support member around a second axis, the second axis and the first axis defining a reference plane;
wherein the parallel linkage mechanism is configured to adopt a state in which the first driving link and the second driving link are crossed, the connection joint is positioned on a primary side of the reference plane, and the first and second intermediate joints are positioned on an opposite, secondary side of the reference plane.

9. The industrial robot of claim 8, further comprising a base and a base actuator arranged to drive the support member to rotate relative to the base around a support member axis.

10. The industrial robot of claim 9, wherein the support member axis is transverse to the reference plane.

11. The industrial robot of claim 10, further comprising a serial linkage mechanism connected between the connection joint and the end effector.

12. The industrial robot of claim 11, wherein the serial linkage mechanism comprises a third driving link and a third actuator arranged to drive the third driving link to rotate relative to each of the first arm and the second arm around a third axis.

13. The industrial robot of claim 12, wherein the third axis coincides with the connection joint.

14. The industrial robot of claim 12, wherein the third axis is parallel with the first axis.

15. The industrial robot of claim 11, wherein the serial linkage mechanism further comprises a fourth driving link and a fourth actuator arranged to drive the fourth driving link to rotate relative to the third driving link around a fourth axis.

16. The industrial robot of claim 15, wherein the fourth axis is parallel with the third axis.

17. The industrial robot of claim 16, wherein the serial linkage mechanism further comprises a fifth driving link and a fifth actuator arranged to drive the fifth driving link to rotate relative to the fourth driving link around a fifth axis.
